(19) United States
(12) Patent Application Publication
(10) Pub. No.: US 2021/0387331 A1
(43) Pub. Date: Dec. 16, 2021

(54) THREE-FINGER MECHANICAL GRIPPER SYSTEM AND TRAINING METHOD THEREOF

(71) Applicant: TAMKANG UNIVERSITY, New Taipei City (TW)

(72) Inventors: CHING-CHANG WONG, TAIPEI CITY (TW); SIANG-LIN YOU, NEW TAIPEI CITY (TW); REN-JIE CHEN, TAOYUAN CITY (TW); YU-LUN LIN, Taipei City (TW)

(21) Appl. No.: 17/236,214

(22) Filed: Apr. 21, 2021

(30) Foreign Application Priority Data
Jun. 10, 2020 (TW) 109119448

(51) Int. Cl. B25J 9/16; B25J 13/08; B25J 15/10

(52) U.S. Cl. CPC B25J 9/163; B25J 9/1612; B25J 9/1633; B25J 13/085; G05B 2219/39466; B25J 15/103; G05B 2219/39496; G05B 2219/33034; B25J 9/1697

(57) ABSTRACT

A three-finger mechanical gripper system is provided, which includes a torque sensor, a three-finger mechanical gripper, an image capturing module and a controller. The three-finger mechanical gripper is connected to the torque sensor. The controller is connected to the torque sensor, the three-finger mechanical gripper and the image capturing module. The image capturing module captures the image of a training object. The controller controls the three-finger mechanical gripper to grip the training object by a plurality of gripper postures respectively and calculates the torque information of each gripper posture according to the measured values of the torque sensor. Then, the controller performs a training process according to the image of the training object and the torque information of the gripper postures in order to obtain a training result of the training object.

### CROSS REFERENCE TO RELATED APPLICATION

All related applications are incorporated by reference. The present application is based on, and claims priority from, Taiwan Application Serial Number 109119448, filed on Jun. 10, 2020, the disclosure of which is hereby incorporated by reference herein in its entirety.

### TECHNICAL FIELD

The technical field relates to mechanical gripper system, in particular to a three-finger mechanical gripper system. The technical field further relates to the training method of the three-finger mechanical gripper system.

### BACKGROUND

With advance of artificial intelligence (AI) technology, the functions of robots are more and more powerful. Currently, robots have been comprehensively applied to various industries. Besides, service robots designed for home service or shopping malls gradually get more people's attention. The service robots may need to grip various objects with different shapes. Thus, it is more difficult to train the service robots when compared with industrial robots designed for factories. However, there is no proper training mechanism for currently available service robots, so the service robots cannot effectively grip objects with complicated shapes.

### SUMMARY

An embodiment of the disclosure relates to a three-finger mechanical gripper system, which includes a torque sensor, a three-finger mechanical gripper, an image capturing module and a controller. The three-finger mechanical gripper is connected to the torque sensor. The controller is connected to the torque sensor, the three-finger mechanical gripper and the image capturing module. The image capturing module captures the image of a training object. The controller controls the three-finger mechanical gripper to grip the training object by a plurality of gripper postures respectively and calculates the torque information of each of the gripper postures according to measured values of the torque sensor. The controller performs a machine learning algorithm to execute a training process according to the image of the training object and the torque information of the gripper postures in order to obtain the training result of the training object.

In one embodiment of the disclosure, three-finger mechanical gripper system further includes a robotic arm connected to the controller and further connected to the three-finger mechanical gripper via the torque sensor.

In one embodiment of the disclosure, the one side of the torque sensor is fixed on the robotic arm and the other side of the torque sensor is fixed on the three-finger mechanical gripper.

In one embodiment of the disclosure, the flange face of the robotic arm is horizontal to the plane where the training object is disposed.

In one embodiment of the disclosure, when the three-finger mechanical gripper selects one of the gripper postures to grip the training object, the controller obtains the x-axis torque measured value, the y-axis torque measured value and the z-axis torque measured value of the torque sensor. Then, the controller calculates the sum of squares of the x-axis torque measured value, the y-axis torque measured value and the z-axis torque measured value, and calculates the square root of the sum of squares so as to use the square root to serve as the torque information of the gripper posture selected.

In one embodiment of the disclosure, when the square root is less than a predetermined value, the controller determines that the gripper posture selected is an ideal gripper posture.

In one embodiment of the disclosure, the controller controls the three-finger mechanical gripper to move according to the depth information of the image of the training object.

In one embodiment of the disclosure, the controller determines whether the training object has been gripped by the three-finger mechanical gripper or not according to the weight information obtained from the torque sensor.

In one embodiment of the disclosure, the machine learning algorithm is Deep Reinforcement Learning Algorithm.

In one embodiment of the disclosure, the image capturing module is a red-green-blue depth camera.

Another embodiment of the disclosure relates to a training method of a three-finger mechanical gripper system, which includes the following steps: capturing the image of a training object by an image capturing module; controlling a three-finger mechanical gripper to grip the training object via a plurality of gripper postures respectively by a controller; calculating the torque information of each of the gripper postures according to measured values of a torque sensor by the controller; and performing a machine learning algorithm to execute a training process according the image of the training object and the torque information of the gripper postures by the controller in order to obtain the training result of the training object.

In one embodiment of the disclosure, the controller is connected to a robotic arm, and the robotic arm is connected to the three-finger mechanical gripper via the torque sensor.

In one embodiment of the disclosure, the one side of the torque sensor is fixed on the robotic arm and the other side of the torque sensor is fixed on the three-finger mechanical gripper.

In one embodiment of the disclosure, the flange face of the robotic arm is horizontal to the plane where the training object is disposed.

In one embodiment of the disclosure, the step of calculating the torque information of each of the gripper postures according to the measured values of the torque sensor by the controller further includes the following steps: selecting one of the gripper postures and controlling the three-finger mechanical gripper to grip the training object by the controller in order to obtain the x-axis torque value, the y-axis torque value and the z-axis torque value of the torque sensor; and calculating the sum of squares of the x-axis torque value, the y-axis torque value and the z-axis torque value, and calculating the square root of the sum of squares by the controller in order to uses the square root to serve as the torque information of the gripper posture selected.

In one embodiment of the disclosure, the step of performing the machine learning algorithm to execute the training process according the image of the training object and the torque information of the gripper postures by the controller in order to obtain the training result of the training object further includes the following step: determining that the gripper posture selected is an ideal gripper posture by the controller when the square root is less than a predetermined value.

In one embodiment of the disclosure, the training method further includes the following step: controlling the three-finger mechanical gripper to move according to the depth information of the image of the training object by the controller.

In one embodiment of the disclosure, the training method further includes the following step: determining whether the training object has been gripped by the three-finger mechanical gripper or not according to the weight information obtained from the torque sensor by the controller.

In one embodiment of the disclosure, the machine learning algorithm is Deep Reinforcement Learning Algorithm.

In one embodiment of the disclosure, the image capturing module is a red-green-blue depth camera.

The three-finger mechanical gripper system and the training method therefore according to the embodiments of the disclosure may include the following advantages:

(1) According to one embodiment of the disclosure, the three-finger mechanical gripper system can obtain the training results of a plurality of training objects by performing a training process according to the measured values of a torque sensor and a machine learning algorithm in order to establish a training database including the above training results. Then, the three-finger mechanical gripper system can grip a target object according to the training database and the image of the target object by an ideal gripper posture. Accordingly, the three-finger mechanical gripper system can stably grip various objects having complicated shapes, so can achieve great performance

(2) According to one embodiment of the disclosure, the three-finger mechanical gripper system can control a robotic arm and a three-finger mechanical gripper to move according to the depth information of an image capturing module. Accordingly, the three-finger mechanical gripper system can avoid that the three-finger mechanical gripper collides with the target object, so the safety of the three-finger mechanical gripper system can be enhanced.

(3) According to one embodiment of the disclosure, the training database of the three-finger mechanical gripper system can expanded by adding more training results, so the three-finger mechanical gripper system can grip more objects having different shapes, which is more flexible in use.

(4) According to one embodiment of the disclosure, the three-finger mechanical gripper adopts by the three-finger mechanical gripper system is of high degree of freedom. That is to say, the gripper posture of the three-finger mechanical gripper can be changed according to the shape of the target object. Thus, the three-finger mechanical gripper system can more stably grip any object having complicated shape, so the application thereof can be more comprehensive.

(5) According to one embodiment of the disclosure, the three-finger mechanical gripper system can achieve the desired technical effects without significantly increasing the cost thereof, so the three-finger mechanical gripper system can provide high commercial value.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a block diagram of a three-finger mechanical gripper system in accordance with a first embodiment of the disclosure.

FIG. 2 is a flow chart of a training method of the three-finger mechanical gripper system in accordance with the first embodiment of the disclosure.

FIG. 3 is a view illustrating a structure of the three-finger mechanical gripper system in accordance with a second embodiment of the disclosure.

FIG. 4 is a view illustrating a structure of a three-finger mechanical gripper of the three-finger mechanical gripper system in accordance with the second embodiment of the disclosure.

FIG. 5A˜FIG. 5C are views illustrating several gripper postures of the three-finger mechanical gripper system in accordance with the second embodiment of the disclosure.

FIG. 6 is a flow chart of a training method of the three-finger mechanical gripper system in accordance with the second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

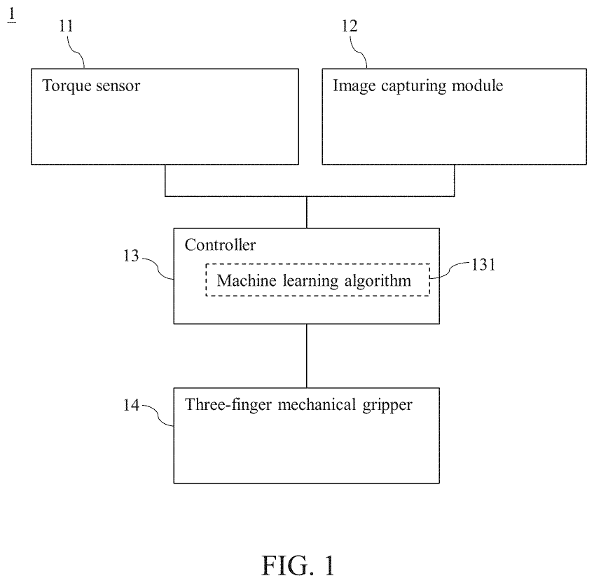

Please refer to FIG. 1, which is a block diagram of a three-finger mechanical gripper system in accordance with a first embodiment of the disclosure. As shown in FIG. 1, the three-finger mechanical gripper system 1 includes a torque sensor 11, an image capturing module 12, a controller 13 and a three-finger mechanical gripper 14.

The three-finger mechanical gripper 14 is connected to the torque sensor 11. In one embodiment, the torque sensor 11 may be a multi-DOF F(force)/T(torque) sensor (e.g. 6-DOF F/T sensor).

The controller 13 is connected to the torque sensor 11, three-finger mechanical gripper 14 and the image capturing module 12. In one embodiment, the controller 13 may be a MCU, a CPU or other computer devices. In one embodiment, the image capturing module 12 may be a red-green-blue (RGB) camera, a RGB-D (depth) camera or other similar devices.

The three-finger mechanical gripper system 1 can perform a training process for training objects having different shapes respectively, such that the three-finger mechanical gripper system 1 can properly adjust the gripper posture of the gripper thereof according to the shape of a target object. Thus, the three-finger mechanical gripper system 1 can successfully grip various objects with different shapes.

In the training process, the image capturing module 12 captures the image of a training object and the controller 13 controls the three-finger mechanical gripper 14 to grip the training object by a plurality of gripper postures respectively. Then, the controller 13 calculates the torque information of each of the gripper postures according to the measured values of the torque sensor 11. In addition, the controller 13 can control the three-finger mechanical gripper 14 to move according to the depth information of the image of the training object with a view to avoid that the three-finger mechanical gripper 14 collides with the training object. Afterward, the controller 13 can perform a machine learning algorithm 131 to execute the training process according to the image of the training object and the torque information of the gripper postures so as to obtain the training result of the training object. The training result includes the ideal gripper posture for the three-finger mechanical gripper 14 to stably grip the training object. Then, the controller 13 repeats the above steps to perform the training process for other training objects having different shapes with a view to obtain the training results of these training objects, such that a training database can be established. In one embodiment, the machine learning algorithm 131 may be Deep Reinforcement Learning Algorithm or other similar algorithms.

After the training process is finished, the three-finger mechanical gripper system 1 can grip various target objects according to the training database. When the three-finger mechanical gripper system 1 is going to grip a target object, the image capturing module 12 captures the image of the target object. Then, the controller 13 compares the image of the target object with the training database in order to select the ideal gripper posture corresponding to the shape of the target object. Afterward, the controller 13 adjusts the gripper posture of the three-finger mechanical gripper 14 to the ideal gripper posture and then controls the three-finger mechanical gripper 14 to grip the target object. Meanwhile, the controller 13 can control the three-finger mechanical gripper 14 to move according to the depth information of the image of the target object so as to avoid that the three-finger mechanical gripper 14 collides with the target object.

As described above, the three-finger mechanical gripper system 1 can calculate the torque information according to the measured values detected by the torque sensor 11 when the three-finger mechanical gripper 14 grips the target object, and can perform the training process via the machine learning algorithm 131. The above mechanism can precisely find out the ideal gripper postures for objects having different shapes, so the three-finger mechanical gripper system 1 can stably grip objects having different shapes, Accordingly, the three-finger mechanical gripper system 1 can achieve great performance.

The embodiment just exemplifies the disclosure and is not intended to limit the scope of the disclosure. Any equivalent modification and variation according to the spirit of the disclosure is to be also included within the scope of the following claims and their equivalents.

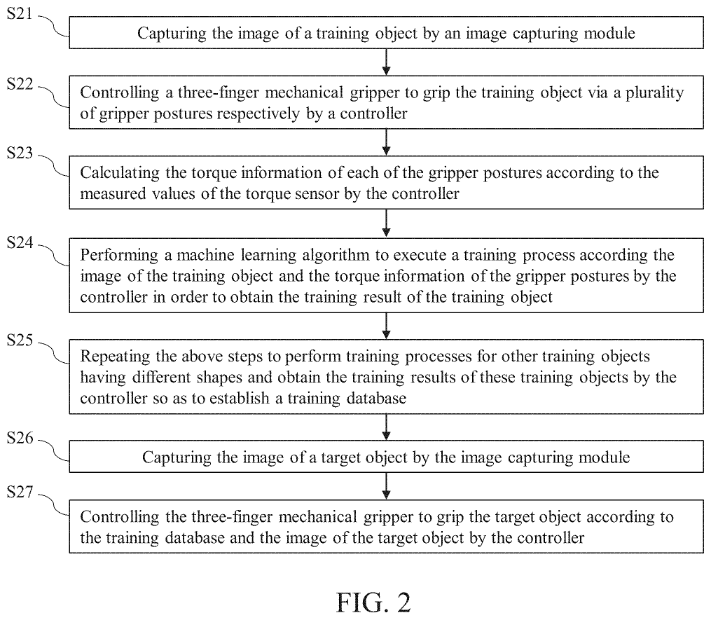

Please refer to FIG. 2, which is a flow chart of a training method of the three-finger mechanical gripper system in accordance with the first embodiment of the disclosure. As shown in FIG. 2, the training method of the three-finger mechanical gripper system 1 includes the following steps:

Step S21: capturing the image of a training object by an image capturing module.

Step S22: controlling a three-finger mechanical gripper to grip the training object via a plurality of gripper postures respectively by a controller.

Step S23: calculating the torque information of each of the gripper postures according to the measured values of the torque sensor by the controller.

Step S24: performing a machine learning algorithm to execute a training process according the image of the training object and the torque information of the gripper postures by the controller in order to obtain the training result of the training object.

Step S25: repeating the above steps to perform training processes for other training objects having different shapes and obtain the training results of these training objects by the controller so as to establish a training database.

Step S26: capturing the image of a target object by the image capturing module.

Step S27: controlling the three-finger mechanical gripper to grip the target object according to the training database and the image of the target object by the controller.

It is worthy to point out that there is no proper training mechanism for currently available service robots, so the service robots cannot effectively grip objects with complicated shapes. On the contrary, according to one embodiment of the disclosure, the three-finger mechanical gripper system can obtain the training results of a plurality of training objects by performing a training process according to the measured values of a torque sensor and a machine learning algorithm in order to establish a training database including the above training results. Then, the three-finger mechanical gripper system can grip a target object according to the training database and the image of the target object by an ideal gripper posture. Accordingly, the three-finger mechanical gripper system can stably grip various objects having complicated shapes, so can achieve great performance.

Also, according to one embodiment of the disclosure, the three-finger mechanical gripper system can control a robotic arm and a three-finger mechanical gripper to move according to the depth information of an image capturing module. Accordingly, the three-finger mechanical gripper system can avoid that the three-finger mechanical gripper collides with the target object, so the safety of the three-finger mechanical gripper system can be enhanced.

Further, according to one embodiment of the disclosure, the training database of the three-finger mechanical gripper system can expanded by adding more training results, so the three-finger mechanical gripper system can grip more objects having different shapes, which is more flexible in use.

Moreover, according to one embodiment of the disclosure, the three-finger mechanical gripper adopts by the three-finger mechanical gripper system is of high degree of freedom. That is to say, the gripper posture of the three-finger mechanical gripper can be changed according to the shape of the target object. Thus, the three-finger mechanical gripper system can more stably grip any object having complicated shape, so the application thereof can be more comprehensive.

Furthermore, according to one embodiment of the disclosure, the three-finger mechanical gripper system can achieve the desired technical effects without significantly increasing the cost thereof, so the three-finger mechanical gripper system can provide high commercial value.

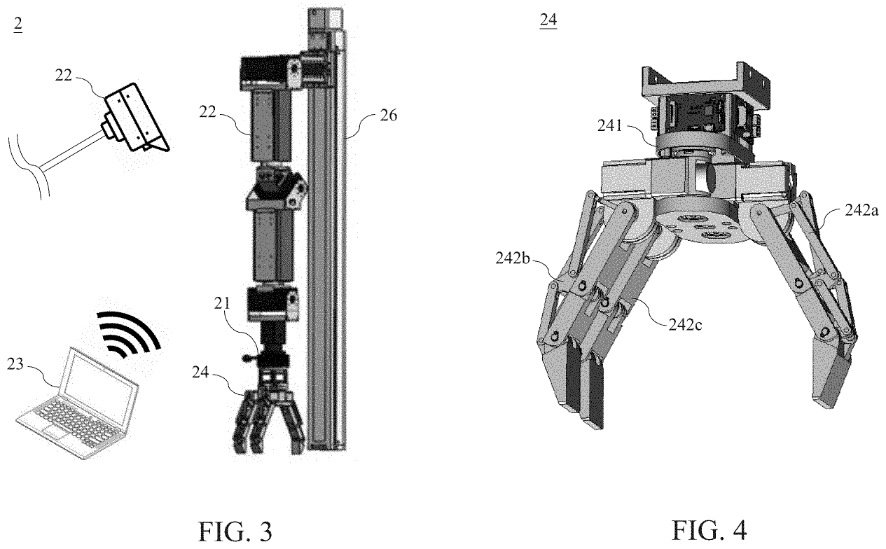

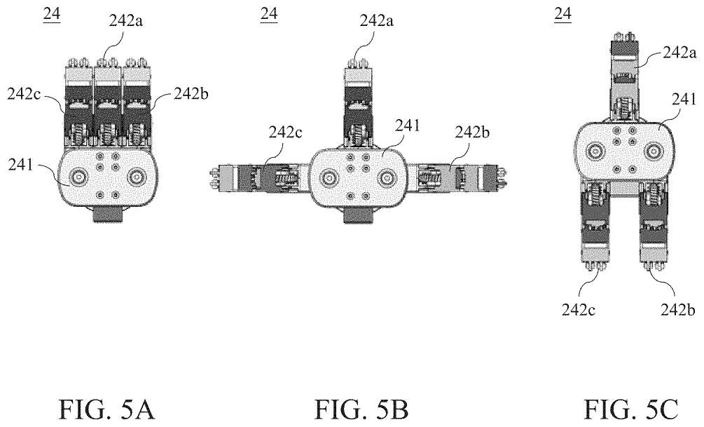

Please refer to FIG. 3, FIG. 4 and FIG. 5A˜FIG. 5C, which are a view illustrating the structure of the three-finger mechanical gripper system, a view of illustrating the structure of the three-finger mechanical gripper of the three-finger mechanical gripper system and views illustrating several gripper postures of the three-finger mechanical gripper system in accordance with the second embodiment of the disclosure respectively. As shown in FIG. 3, the three-finger mechanical gripper system 2 includes a torque sensor 21, a RGB-D camera 22, a computer device 23, a three-finger mechanical gripper 24, a robotic arm 25 and a holder 26.

The robotic arm 25 is disposed on the holder 26.

The three-finger mechanical gripper 24 is connected to the robotic arm 25 via the torque sensor 21. One side of the torque sensor 21 is fixed on the robotic arm 25 and the other side of the torque sensor 21 is fixed on the three-finger mechanical gripper 24. Besides, the flange face of the robotic arm 25 is horizontal to the plane where a training object is disposed.

The computer device 23 is wirelessly or wiredly connected to the torque sensor 21, the robotic arm 25, the three-finger mechanical gripper 24 and the RGB-D camera.

As shown in FIG. 4, the three-finger mechanical gripper 24 includes a base 241, a first finger portion 242a, a second finger portion 242b and a third finger portion 242c. The first finger portion 242a, the second finger portion 242b and the third finger portion 242c are pivotably connected to the base 241, such that the gripper posture of the three-finger mechanical gripper 24 can be adjusted. As shown in 5A, the first finger portion 242a, the second finger portion 242b and the third finger portion 242c can be rotated to make them be on the same side of the base 241, which forms a first gripper posture. As shown in 5B, the first finger portion 242a, the second finger portion 242b and the third finger portion 242c can be rotated to make them be on the different side of the base 241 respectively, and the second finger portion 242b is opposite to the third finger portion 242c, which forms a second gripper posture. As shown in 5C, the first finger portion 242a, the second finger portion 242b and the third finger portion 242c can be rotated to make the second finger portion 242b and the third finger portion 242c be on the same side of the base 241, and the first finger portion 242a is opposite to the second finger portion 242b and the third finger portion 242c, which forms a third gripper posture.

As shown in FIG. 3, the three-finger mechanical gripper system 2 can perform training processes for objects having different shapes. Thus, the three-finger mechanical gripper system 2 can properly adjust the gripper posture thereof according to the shape of a target object, such that the three-finger mechanical gripper system 2 can successfully grip different target objects having different shapes.

In the training process, the RGB-D camera 22 captures the image of a training object and the computer device 23 controls the robotic arm 25 and the three-finger mechanical gripper 24 to grip the training object by a plurality of gripper postures respectively. Then, the computer device 23 calculates the torque information of each of the gripper postures according to the measured values of the torque sensor 21. In addition, the computer device 23 can control the robotic arm 25 and the three-finger mechanical gripper 24 to move according to the depth information of the image of the training object with a view to avoid that the robotic arm 25 and the three-finger mechanical gripper 24 collides with the training object.

Next, the computer device 23 performs Deep Reinforcement Learning Algorithm to execute the training process according to the image of the training object and the torque information of the gripper postures so as to obtain the training result of the training object. When the computer device 23 selects one of the gripper postures and controls the robotic arm 25 and the three-finger mechanical gripper 24 to grip the training object by the selected gripper posture, the computer device 23 can control the action of the three-finger mechanical gripper 24 according to the depth information of the image of the training object so as to avoid that the three-finger mechanical gripper 24 collides with the training object. Meanwhile, the computer device 23 determines whether the training object has been gripped by the three-finger mechanical gripper 24 according to the weight information of the torque sensor 21. If the training object has been gripped by the three-finger mechanical gripper 24, the computer device 23 receives the x-axis torque measured value, the y-axis torque measured value and the z-axis torque measured value of the torque sensor 21. Then, the computer device 23 calculates the sum of squares of the x-axis torque measured value, the y-axis torque measured value and the z-axis torque measured value, and calculates the square root of the sum of squares, such that the computer device 23 can use the square root to serve as the torque information of the selected gripper posture, as shown in Equation (1) given below:

M_{f}=\sqrt{Mx²+My²+Mz²} (1)

In Equation (1), M_{f} stands for the torque information; Mₓ stands for the x-axis torque measured value; M_{y} stands for the y-axis torque measured value; M_{z} stands for the z-axis torque measured value.

When the torque information is less than a predetermined value, the computer device 23 determines that the selected gripper posture is an ideal gripper posture. The above predetermined value can be selected according to actual requirements.

Similarly, the computer device 23 repeats the above steps in order to perform the training processes for more training objects having different shapes respectively so as to obtain the training results of these training objects, such that the computer device 23 can establish a training database. After the training process is finished, the three-finger mechanical gripper system 2 can grip various target objects according to the training database. When the three-finger mechanical gripper system 2 is going to grip a target object, the RGB-D camera 22 captures the image of the target object. Then, the computer device 23 compares the image of the target object with the training database in order to select the ideal gripper posture corresponding to the shape of the target object. Afterward, the computer device 23 adjusts the gripper posture of the three-finger mechanical gripper 24 to the ideal gripper posture and then controls the three-finger mechanical gripper 24 to grip the target object.

As set forth above, the three-finger mechanical gripper system 2 can calculate the torque information detected by the torque sensor 21 when the three-finger mechanical gripper 24 grips the training object and then perform Deep Reinforcement Learning Algorithm to execute the training process. Thus, three-finger mechanical gripper system 2 can stably grip objects having different shapes by the ideal gripper postures.

Besides, as described above, the three-finger mechanical gripper 24 adopts by the three-finger mechanical gripper system 2 is of high degree of freedom, such that the gripper posture of the three-finger mechanical gripper 24 can be changed according to the shape of the target object so as to more stably grip any object having complicated shape.

Moreover, the training database of the three-finger mechanical gripper system 2 can expanded by adding more training results of objects having different shapes, so the three-finger mechanical gripper system 2 can grip more objects having complicated shapes.

Furthermore, the three-finger mechanical gripper system 2 can control the robotic arm 25 and the three-finger mechanical gripper 24 to move according to the depth information of the images captured by the RGB-D camera 22. Accordingly, the three-finger mechanical gripper system 2 can avoid that the three-finger mechanical gripper 24 collides with the target object, so the safety of the three-finger mechanical gripper system 2 can be enhanced.

The embodiment just exemplifies the disclosure and is not intended to limit the scope of the disclosure. Any equivalent modification and variation according to the spirit of the disclosure is to be also included within the scope of the following claims and their equivalents.

This embodiment performs the training processes for several training objects, including a hammer, a cable clamp, a bottled detergent and a metal part, and obtains the x-axis torque measured value (Mₓ), the y-axis torque measured value (M_{y}), the z-axis torque measured value (Mₜ) and the torque information (M_{f}) of the three-finger mechanical gripper 24 gripping each of the training objects by the ideal gripper posture corresponding thereto, as shown in Table 1 given below:

TABLE 1

| | Hammer | Cable clamp | Bottled detergent | Metal part |
|---|---|---|---|---|
| Mₓ | −0.9 Nm | −0.01 Nm | 0.07 Nm | 0.03 Nm |
| M_{y} | 0.65 Nm | 0.00 Nm | −0.07 Nm | −0.10 Nm |
| M_{z} | 0.00 Nm | 0.00 Nm | 0.04 Nm | 0.03 Nm |
| M_{f} | 0.656201 | 0.01 | 0.106771 | 0.108628 |

The predetermined value for selecting the ideal gripper posture of each training object can be determined according to actual requirements or the three-finger mechanical gripper system 2 can use the gripper posture having lowest torque information to serve as the ideal gripper posture. Different training objects may be corresponding to different predetermined values.

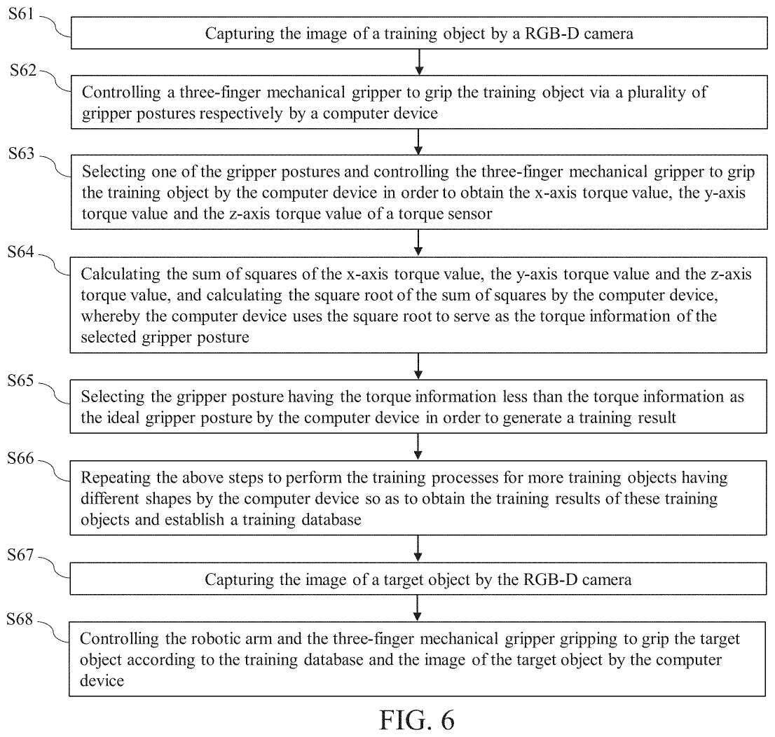

Please refer to FIG. 6, which is a flow chart of a training method of the three-finger mechanical gripper system in accordance with the second embodiment of the disclosure. As shown in FIG. 6, the training method of the three-finger mechanical gripper system 2 may include the following steps:

Step S61: capturing the image of a training object by a RGB-D camera.

Step S62: controlling a three-finger mechanical gripper to grip the training object via a plurality of gripper postures respectively by a computer device.

Step S63: selecting one of the gripper postures and controlling the three-finger mechanical gripper to grip the training object by the computer device in order to obtain the x-axis torque value, the y-axis torque value and the z-axis torque value of a torque sensor.

Step S64: calculating the sum of squares of the x-axis torque value, the y-axis torque value and the z-axis torque value, and calculating the square root of the sum of squares by the computer device, whereby the computer device uses the square root to serve as the torque information of the selected gripper posture.

Step S65: selecting the gripper posture having the torque information less than the torque information as the ideal gripper posture by the computer device in order to generate a training result.

Step S66: repeating the above steps to perform the training processes for more training objects having different shapes by the computer device so as to obtain the training results of these training objects and establish a training database.

Step S67: capturing the image of a target object by the RGB-D camera.

Step S68: controlling the robotic arm and the three-finger mechanical gripper gripping to grip the target object according to the training database and the image of the target object by the computer device.

To sum up, according to one embodiment of the disclosure, the three-finger mechanical gripper system can obtain the training results of a plurality of training objects by performing a training process according to the measured values of a torque sensor and a machine learning algorithm in order to establish a training database including the above training results. Then, the three-finger mechanical gripper system can grip a target object according to the training database and the image of the target object by an ideal gripper posture. Accordingly, the three-finger mechanical gripper system can stably grip various objects having complicated shapes, so can achieve great performance.

Also, according to one embodiment of the disclosure, the three-finger mechanical gripper system can control a robotic arm and a three-finger mechanical gripper to move according to the depth information of an image capturing module. Accordingly, the three-finger mechanical gripper system can avoid that the three-finger mechanical gripper collides with the target object, so the safety of the three-finger mechanical gripper system can be enhanced.

Besides, according to one embodiment of the disclosure, the training database of the three-finger mechanical gripper system can expanded by adding more training results, so the three-finger mechanical gripper system can grip more objects having different shapes, which is more flexible in use.

Moreover, according to one embodiment of the disclosure, the three-finger mechanical gripper adopts by the three-finger mechanical gripper system is of high degree of freedom. That is to say, the gripper posture of the three-finger mechanical gripper can be changed according to the shape of the target object. Thus, the three-finger mechanical gripper system can more stably grip any object having complicated shape, so the application thereof can be more comprehensive.

Furthermore, according to one embodiment of the disclosure, the three-finger mechanical gripper system can achieve the desired technical effects without significantly increasing the cost thereof, so the three-finger mechanical gripper system can provide high commercial value.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A three-finger mechanical gripper system, comprising:
a torque sensor;
a three-finger mechanical gripper, connected to the torque sensor;
an image capturing module; and
a controller, connected to the torque sensor, the three-finger mechanical gripper and the image capturing module;
wherein the image capturing module captures an image of a training object, and the controller controls the three-finger mechanical gripper to grip the training object by a plurality of gripper postures respectively and calculates a torque information of each of the gripper postures according to measured value of the torque sensor, wherein the controller performs a machine learning algorithm to execute a training process according to the image of the training object and the torque information of the gripper postures in order to obtain a training result of the training object.

2. The three-finger mechanical gripper system of claim 1, further comprising a robotic arm connected to the controller and further connected to the three-finger mechanical gripper via the torque sensor.

3. The three-finger mechanical gripper system of claim 2, wherein the one side of the torque sensor is fixed on the robotic arm and the other side of the torque sensor is fixed on the three-finger mechanical gripper.

4. The three-finger mechanical gripper system of claim 2, wherein a flange face of the robotic arm is horizontal to a plane where the training object is disposed.

5. The three-finger mechanical gripper system of claim 1, wherein when the three-finger mechanical gripper selects one of the gripper postures to grip the training object, the controller obtains a x-axis torque measured value, a y-axis torque measured value and a z-axis torque measured value of the torque sensor, wherein the controller calculates a sum of squares of the x-axis torque measured value, the y-axis torque measured value and the z-axis torque measured value, and calculates a square root of the sum of squares, whereby the controller uses the square root to serve as the torque information of the gripper posture selected.

6. The three-finger mechanical gripper system of claim 5, wherein when the square root is less than a predetermined value, the controller determines that the gripper posture selected is an ideal gripper posture.

7. The three-finger mechanical gripper system of claim 1, wherein the controller controls the three-finger mechanical gripper to move according to a depth information of the image of the training object.

8. The three-finger mechanical gripper system of claim 1, wherein the controller determines whether the training object has been gripped by the three-finger mechanical gripper or not according to a weight information obtained from the torque sensor.

9. The three-finger mechanical gripper system of claim 1, wherein the machine learning algorithm is a deep reinforcement learning algorithm.

10. The three-finger mechanical gripper system of claim 1, wherein the image capturing module is a red-green-blue depth camera.

11. A training method of a three-finger mechanical gripper system, comprising:
capturing an image of a training object by an image capturing module;
controlling a three-finger mechanical gripper to grip the training object via a plurality of gripper postures respectively by a controller;
calculating a torque information of each of the gripper postures according to measured values of a torque sensor by the controller; and
performing a machine learning algorithm to execute a training process according the image of the training object and the torque information of the gripper postures by the controller in order to obtain a training result of the training object.

12. The training method of claim 11, wherein the controller is connected to a robotic arm, and the robotic arm is connected to the three-finger mechanical gripper via the torque sensor.

13. The training method of claim 12, wherein the one side of the torque sensor is fixed on the robotic arm and the other side of the torque sensor is fixed on the three-finger mechanical gripper.

14. The training method of claim 12, wherein a flange face of the robotic arm is horizontal to a plane where the training object is disposed.

15. The training method of claim 11, wherein a step of calculating the torque information of each of the gripper postures according to the measured values of the torque sensor by the controller further comprises:
selecting one of the gripper postures and controlling the three-finger mechanical gripper to grip the training object by the controller in order to obtain a x-axis torque value, a y-axis torque value and a z-axis torque value of the torque sensor; and
calculating a sum of squares of the x-axis torque value, the y-axis torque value and the z-axis torque value, and calculating a square root of the sum of squares by the controller, whereby the controller uses the square root to serve as the torque information of the gripper posture selected.

16. The training method of claim 15, wherein a step of performing the machine learning algorithm to execute the training process according the image of the training object and the torque information of the gripper postures by the controller in order to obtain the training result of the training object further comprises:
determining that the gripper posture selected is an ideal gripper posture by the controller when the square root is less than a predetermined value.

17. The training method of claim 11, further comprises:
controlling the three-finger mechanical gripper to move according to a depth information of the image of the training object by the controller.

18. The training method of claim 11, further comprises:
determining whether the training object has been gripped by the three-finger mechanical gripper or not according to a weight information obtained from the torque sensor by the controller.

19. The training method of claim 11, wherein the machine learning algorithm is a deep reinforcement learning algorithm.

20. The training method of claim 11, wherein the image capturing module is a red-green-blue depth camera.
